(19) United States
(12) Patent Application Publication
(10) Pub. No.: US 2019/0205081 A1
(43) Pub. Date: Jul. 4, 2019

(54) Method For Displaying Image On Display Device, Display Device, And Electronic Apparatus

(71) Applicant: BOE TECHNOLOGY GROUP CO., LTD., Beijing (CN)

(72) Inventor: Lin ZHU, Beijing (CN)

(21) Appl. No.: 16/050,659

(22) Filed: Jul. 31, 2018

(30) Foreign Application Priority Data
Jan. 2, 2018 (CN) 201810001225.7

(51) Int. Cl. G06F 3/14; G06F 3/0484

(52) U.S. Cl. CPC G06F 3/1446; G06F 3/0484

(57) ABSTRACT

Embodiments of the present disclosure disclose a method for displaying an image on a display device, a display device and an electronic apparatus. The method includes acquiring environmental information for the display device, and determining display parameters of the display device for image display according to the environmental information.

### CROSS REFERENCE TO RELATED APPLICATION

This application claims the benefit and priority of Chinese Patent Application No. 201810001225.7 filed Jan. 2, 2018. The entire disclosure of the above application is incorporated herein by reference.

### FIELD

The present disclosure relates to the field of display technologies, and in particular, to a method for displaying an image on a display device, a display device, and an electronic apparatus.

### BACKGROUND

This section provides background information related to the present disclosure which is not necessarily prior art.

With the improvement of people's living standards, people's appreciation of art is also increasing. More and more people decorate rooms with paintings such as ink and wash paintings, oil paintings. However, due to space and cost constraints, people can't have all the favorite paintings or exhibit them all for appreciation. Currently, display devices that can store a large number of images are provided. Display device directly display images, but as display parameters for images are unchanged, the display effects remain unchanged. It is desirable to improve the quality of images displayed by display devices.

### SUMMARY

Embodiments of the present disclosure provide a method for displaying an image on a display device, a display device, and an electronic apparatus.

According to a first aspect of the present disclosure, there is provided a method for displaying an image on a display device. In the method, first acquiring environmental information for the display device, and then determining display parameters of the display device for image display according to the environmental information.

In an embodiment of the present disclosure, acquiring the environmental information for the display device may include acquiring a geographic position and current time for the display device, and acquiring weather information corresponding to the geographic position and the current time.

In an embodiment of the present disclosure, determining display parameters of the display device for image display according to the environmental information may include determining color temperature and luminance of light based on the weather information and the current time, and determining the display parameters of the display device based on the determined color temperature and luminance.

In an embodiment of the present disclosure, acquiring environmental information of the display device may include capturing an indoor image of an indoor environment in which the display device is located, and analyzing the indoor image to determine display parameters of the indoor image, wherein the display parameters of the display device for image display are determined based on the display parameters of the indoor environment.

In an embodiment of the present disclosure, the method may further include acquiring indoor space information of an indoor environment in which the display device is located, the indoor space information including a position of an illumination source, detecting a position of eyes of a user who is viewing the display device, determining a relative position between the display device and the user's eyes, determining, according to the indoor space information and the relative position, an area of the display device that reflects light from the illumination source to the user's eyes, and adjusting luminance of the display device such that the luminance in the area of the display device is higher than the luminance in other area of the display device.

In an embodiment of the present disclosure, the method may further include storing the display parameters of the display device in association with the environmental information.

In an embodiment of the present disclosure, the display parameters may include at least one of color temperature and luminance.

According to a second aspect of the present disclosure, there is provided a display device. The display device may include an information acquisition module configured to acquire environmental information for the display device, and a processor configured to determine display parameters of the display device for image display according to the environmental information.

In an embodiment of the present disclosure, the information acquisition module may include a communication unit. The communication unit may be configured to receive current time and weather information.

In an embodiment of the present disclosure, the information acquisition module may include a timing system, a positioning unit, and a communication unit. The timing system may be configured to acquire current time for the display device. The positioning unit may be configured to acquire a geographic position for the display device. The communication unit may be configured to transmit the acquired current time and geographic position to an external server and receive from the server weather information corresponding to the geographic position and the current time.

In an embodiment of the present disclosure, the processor may be further configured to determine color temperature and luminance of light based on the weather information and the current time, and determine the display parameters of the display device based on the determined color temperature and luminance.

In an embodiment of the present disclosure, the information acquisition module may include a spectral sensor and a light intensity sensor. The spectral sensor may be configured to acquire color temperature of environmental light. The light intensity sensor may be configured to acquire luminance of the environmental light. The processor may be further configured to determine the display parameters of the display device for image display based on the color temperature and luminance of the environmental light.

In an embodiment of the present disclosure, the information acquisition module may include a camera and an analysis unit. The camera may be configured to capture an indoor image of an indoor environment in which the display device is located. The analysis unit may be configured to analyze the indoor image to determine display parameters of the indoor image. The processor may be further configured to determine the display parameters of the display device for image display based on the display parameters of the indoor image.

In an embodiment of the present disclosure, the display device may further include a binocular camera and an infrared sensor. The binocular camera may be configured to acquire indoor space information of an indoor environment in which the display device is located, the indoor space information including a position of an illumination source. The infrared sensor may be configured to detect a position of eyes of a user who is viewing the display device. The processor may be further configured to determine a relative position between the display device and the user's eyes, determine an area of the display device that reflects light from the illumination source to the user's eyes according to the indoor space information and the relative position, and adjust luminance of the display device such that the luminance in the area of the display device is higher than the luminance in other area of the display device.

In an embodiment of the present disclosure, the display device may further include a memory. The memory may be configured to store the display parameters of the display device corresponding to the environmental information.

In an embodiment of the present disclosure, the display parameters may include at least one of color temperature and luminance.

According to a third aspect of the present disclosure, there is provided an electronic apparatus. The electronic apparatus may include the display device according to the second aspect of the present disclosure.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure

### DRAWINGS

The drawings described herein are for illustrative purposes only of selected embodiments and not all possible implementations, and are not intended to limit the scope of the present disclosure.

FIG. 1 is a schematic flowchart of a method for displaying an image on a display device according to an embodiment of the present disclosure;

FIG. 2 is a schematic flowchart of a process of acquiring outdoor environmental information according to an embodiment of the present disclosure;

FIG. 3 is a schematic flowchart of a process of acquiring indoor environmental information according to an embodiment of the present disclosure;

FIG. 4 is a schematic flowchart of a method for displaying an image on a display device according to another embodiment of the present disclosure;

FIG. 5 is a schematic block diagram of a display device according to an embodiment of the present disclosure; and

FIG. 6 is a schematic block diagram of an electronic apparatus according to an embodiment of the present disclosure.

Corresponding reference numerals indicate corresponding parts or features throughout the several views of the drawings.

### DETAILED DESCRIPTION

Example embodiments will now be described more fully with reference to the accompanying drawings.

Hereinafter, unless otherwise stated, the expression “the element A is coupled to the element B” means that the element A is “directly” connected to the element B or “indirectly” connected to the element B through one or more other elements.

As used herein, unless otherwise stated, the singular form, “one”, “this” or “the”, is also intended to include the plural form.

As used herein, the term “including” or “comprising” refers to the presence of a feature, integer, step, operation, element and/or part, but does not exclude the presence or addition of one or more other features, integers, steps, operations, components, components, and/or combinations thereof.

When a user watches an image, the user is often greatly affected by current environmental light. For example, in dim light, the user is likely to feel the image is darker and the color is yellower and warmer. As described above, when an existing display device displays an image, display parameters (such as color, luminance, contrast, color temperature, and the like) for images are preset, regardless of current environmental light. Therefore, the display effects of images remain unchanged. Therefore, it is desirable that the display of images can be adapted to different application environments.

FIG. 1 is a schematic flowchart of a method for displaying an image on a display device according to an embodiment of the present disclosure. The display device is typically fixed or movably placed indoors to display various images.

As shown in FIG. 1, in step S110, environmental information of the display device can be acquired. The environmental information may be related, for example, to a current outdoor environment, a current indoor environment, or a user-defined scene environment, and will be described in detail below with respect to various environments. In step S120, display parameters of the display device for image display can be determined according to the acquired environmental information. The display device can then be controlled for display based on the determined display parameters.

In an embodiment of the present disclosure, the display parameters may include luminance and/or color temperature. Based on the determined luminance, the current supplied to a backlight source of the display device can be adjusted so as to change luminance of the display device to be the determined luminance. Based on the determined color temperature, the ratio of three colors of R (red), G (green), and B (blue) of images of the display device can be adjusted so as to change color temperature of the display device to be the determined color temperature. For example, the proportion of red color may be increased so as to make the displayed image warmer, or the proportion of blue color may be increased so as to make the displayed image cooler. Thereby, the image can be displayed so as to adapt to various environments, and further provide users with better viewing experience. Those skilled in the art will appreciate that the method of the embodiment of the present disclosure can also be applicable to other display parameters, such as contrast.

With the method of the embodiment of the present disclosure, the display parameters of the display device can be adjusted in real time according to the environmental information, so that the display of images can be adapted to the different application environments.

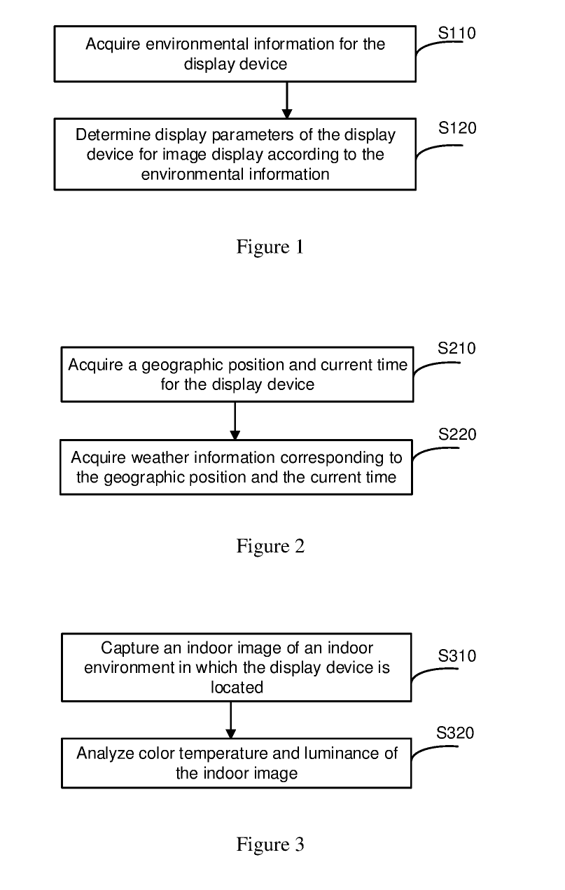

FIG. 2 is a schematic flowchart of a process of acquiring the outdoor environmental information according to an embodiment of the present disclosure. Generally, different time and weather conditions will result in differences in luminance and color temperature of environmental light in an outdoor environment, which in turn will affect the display of images.

Specifically, according to changes of outdoor environmental light in one day, the day can be divided into several time periods, such as early morning (5:00 to 7:00), morning (7:00 to 11:00), noon (11:00 to 13:00), afternoon (13:00 to 17:00), evening (17:00 to 20:00) and late night (20:00 to 5:00 in next day). Generally, luminance of environmental light in the early morning is low, and color temperature is, for example, about 2000K. Luminance of environmental light at noon is strong, and color temperature is, for example, about 5500K. Therefore, the luminance and the color temperature of the environmental light can be generally determined according to the time information (e.g., current time).

In addition, different weather conditions (such as a sunny, cloudy, rainy, or snowy day) may also correspond to different environmental conditions. For example, on a sunny day, the luminance of light in an outdoor environment is high, and the color temperature is warm, for example, about 10,000K. On a cloudy day, the luminance of light in an outdoor environment is weak, and the color temperature is cool, for example, about 6500K. Therefore, the luminance and the color temperature of the environmental light can also be determined approximately according to the weather information.

As above, the time information and the weather information can be used as parameters for determining the luminance and the color temperature of the environmental light. After long-term observation and statistical learning of outdoor environments, data on a corresponding relationship between the time information and the weather information with the color temperature and the luminance of environmental light can be obtained and stored in a database. For example, the color temperature and the luminance of the environmental light in respective with the time information and the weather information can be stored in a database as shown in the following table.

TABLE 1

| Time information | Weather information | Color temperature | Luminance |
|---|---|---|---|
| Early morning | Sunny day | A1 | B1 |
| Morning | Rainy day | A2 | B2 |
| Evening | Snowy day | A3 | B3 |
| . . . | . . . | . . . | . . . |

As shown in FIG. 2, in step S210, a geographic position and current time of the display device can be acquired. In an embodiment, the current time may be acquired, for example, by a timing system of the display device, and a time period corresponding to the current time, such as morning, morning, and the like, may be determined. The geographic position in which the display device is located can be acquired by a positioning unit of the display device, such as a Global Positioning System (GPS). Then, in step S220, the communication unit of the display device may transmit the acquired current time and geographical position to an external server via the Internet or a wireless communication network, and receive from the server the weather information corresponding to the geographic position and the current time, such as a sunny, cloudy, rainy or snowy day.

In a further embodiment, the communication unit of the display device can also receive the current time and the weather information directly from a server in the Internet or a wireless communication network in a wireless or wired manner.

The color temperature and the luminance of light corresponding to the acquired weather information and current time are determined according to the stored data in a database. Then, the color temperature of the display device can be determined based on the color temperature of light in accordance with the current environmental information. For example, it can be determined that the color temperature of the display device is equal to the color temperature of light. Further, the luminance of the display device can be determined based on the luminance of light in accordance with the current environmental information. For example, it can be determined that the luminance of the display device is equal to the luminance of light.

With the above method, the display device located indoors can simulate the current outdoor environment for display, so that the user can feel the effect of viewing images in the current outdoor environment.

FIG. 3 is a schematic flowchart of a process of acquiring the indoor environmental information according to an embodiment of the present disclosure. The color temperature and the luminance of the environmental light indoors can usually be determined by an illumination source and outdoor environmental light introduced through a transparent window, and will affect the display of images. For example, when a photographing fluorescent lamp is arranged indoors, color temperature of environmental light is about 5500K. When a household tungsten lamp is arranged, color temperature is about 2800K. When a fluorescent lamp is arranged, color temperature is above 6000K. In addition, for example, when outdoor light is strong, light is incident into the room through the window to increase the luminance of the indoor light, and vice versa.

As shown in FIG. 3, in step S310, an indoor image of an indoor environment in which the display device is located can be captured by a camera. Then, in step S320, luminance and color temperature of the indoor image ban be determined by analyzing the captured indoor image. Thereby, the color temperature and the luminance of the display device for image display can be determined based on the color temperature and the luminance of the indoor image. Then, the image can be displayed. In the embodiment of the present disclosure, it can be determined that the color temperature and the luminance of the display device are respectively equal to the color temperature and the luminance of the indoor image.

With the above method, the display device can adjust the display parameters based on the current indoor environment, such that the displayed image adapts to the current indoor environment.

In other embodiments of the present disclosure, a spectral sensor and a light intensity sensor provided outdoors or indoors may also be utilized to directly acquire the color temperature and the luminance of the environmental light outdoors or indoors. The processor then determines the color temperature and the luminance of the display device for image display based on the acquired color temperature and luminance.

In addition, the display device can also adjust the luminance and the color temperature according to a preset virtual environment scene to perform image display. For example, the display device can store virtual environment scenes with different display parameters. Alternatively, the display device may also acquire virtual environment scenes with different display parameters via the Internet to perform display. When the user selects a certain virtual environment scene, the display device may determine the corresponding display parameters to display an image based on the selected virtual environment scene.

Further, when the display device displays an image, the indoor environment in which the display device is located and the relative position between the display device and the user viewing the display device may both affect the user's viewing effects. For example, when the illumination source illuminates the display device, light is reflected into the user's eyes via the display device, causing the user to feel that certain areas of the image are very bright. In order to adapt to this environment, an indoor environment model can be established, and the luminance of a specific area of the displayed image can be adjusted accordingly, to improve display effects.

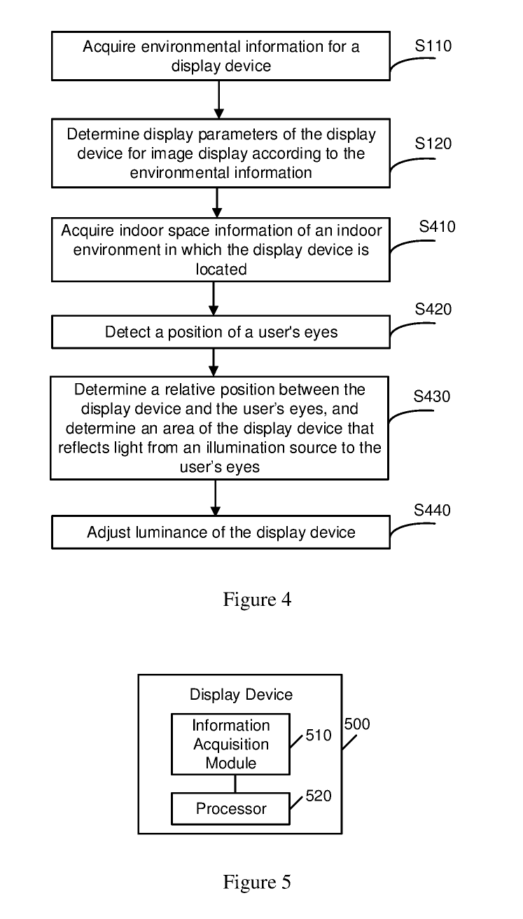

FIG. 4 is a schematic flowchart of a method for displaying an image on a display device according to another embodiment of the present disclosure. After performing the above the steps S110 and S120, indoor space information of the indoor environment in which the display device is located may be acquired in step S410, for example, a binocular camera may be used to capture an indoor image. In addition, based on the indoor image captured by the binocular camera, performing simultaneous localization and mapping (SLAM) to form an indoor map includes the following steps: state vector initialization, state transition prediction, acquisition of observation data, and state vector updating. Specifically, the data obtained by the binocular camera is preprocessed to extract valid feature point information, eliminate deformation influence, track features and then establish a relationship with state vectors through a projection equation. Thereby, according to the captured indoor image, the position and shape of the wall and the window, the position of the illumination source, and the like can be determined. A 3D model can then be constructed to form indoor space information.

In step S420, the position of the eyes of the user who is viewing the display device can be detected by an infrared sensor.

Then in step S430, the relative position between the display device and the user's eyes can be determined. In addition, according to the indoor space information and the relative position, the area of the display device that reflects light from the illumination source to the user's eyes can be determined.

In step S440, luminance of the display device can be adjusted such that the luminance in the reflection area of the display device is higher than the luminance in other area of the display device. For example, by providing a plurality of backlight sources on the back of the display device, the magnitude or duty cycle of current supplied to the backlight source corresponding to the area with strong reflected light can be increased so as to enhance the luminance of the backlight source in the area, thereby enhancing the luminance of the image in this area. Conversely, the magnitude or duty cycle of current provided to the backlights in other area of the display device can also be reduced so as to attenuate luminance of other areas.

By the above method of adjusting luminance in a specific area of the display device, the area with strong reflected light viewed by the user can be made brighter, thereby effectively and accurately reducing the influence of the reflection of light from the illumination source on image display.

Further, the virtual environment scene may also include a scene that changes luminance of a specific area of the display device, such as an art gallery scene. In an art gallery, there is usually an illumination source around a portrait, so reflection light in some area of the portrait will be stronger than in other areas. Accordingly, in the art gallery scene, the luminance in a specific area of the display device can be adjusted such that the luminance in that area is higher than the luminance in other area.

In an embodiment of the present disclosure, the display parameters of the display device determined by the various methods described above may also be stored in association with the environmental information. For example, the display device stores the time and the display parameters of the display device in association with the time, and thereafter the display device can directly invoke the information of the time for display.

FIG. 5 shows a schematic block diagram of a display device 500 according to an embodiment of the present disclosure. The display device 500 includes an information acquisition module 510 and a processor 520 that are communicatively coupled together. The information acquisition module 510 may be configured to acquire environmental information of the display device. The processor 520 may be configured to determine display parameters of the display device for image display according to the acquired environmental information.

According to an embodiment of the present disclosure, the information acquisition module 510 may include a communication unit. The communication unit can receive current time and weather information. In further embodiments, the information acquisition module 510 may include a timing system, a positioning unit, and a communication unit. In particular, the timing system can acquire current time of the display device. A positioning unit (e.g., Global Positioning System (GPS)) can acquire the geographic position of the display device. The communication unit may transmit the acquired current time and geographic position to an external server and receive from the server weather information corresponding to the geographic position and the current time.

In an embodiment of the present disclosure, the processor 520 may further determine color temperature and luminance of light based on the weather information and the current time, and determine the display parameters of the display device based on the color temperature and the luminance.

In an embodiment of the present disclosure, the information acquisition module 510 may further include a spectral sensor and a light intensity sensor. The spectral sensor can acquire the color temperature of environmental light indoors or outdoors. The light intensity sensor can acquire the luminance of environmental light indoors or outdoors. The processor can then be further configured to determine the color temperature and the luminance of the display device for image display based on the color temperature and luminance of environmental light.

According to another embodiment of the present disclosure, the information acquisition module 510 may include a camera and an analysis unit. The camera can capture an indoor image of an indoor environment in which the display device is located. The analysis unit may analyze color temperature and luminance of the indoor image. The analysis unit may be for example an image analyzer. Further, the processor 520 may further determine the color temperature and the luminance of the display device for image display based on the color temperature and the luminance of the indoor image.

Further, the display device 500 may further include a binocular camera that acquires indoor space information of an indoor environment in which the display device is located, the indoor space information including the position of the illumination source. The display device 500 may also include an infrared sensor that can acquire the position of the eyes of a user who is viewing the display device. In addition, the processor 520 may further determine a relative position between the display device and the user's eyes, and determine, according to the indoor space information and the relative position, an area of the display device that reflects light from the illumination source to the user's eyes, and adjust luminance of the display device such that the luminance in that area of the display device is higher than the luminance in other area of the display device.

Further, the display device 500 may further include a memory. The memory stores the display parameters of the display device corresponding to the environmental information.

Thus, the display device 500 can perform various methods for displaying an image on a display device according to the embodiments of the present disclosure.

The unit or module described herein may be implemented as a combination of a processor and a memory, wherein the processor executes a program stored in the memory to implement the functionality of the respective unit or module. The unit or module described herein may also be implemented in a complete hardware implementation, including an application specific integrated circuit (ASIC), field programmable gate array (FPGA), and the like.

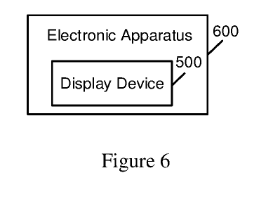

FIG. 6 shows a schematic block diagram of an electronic apparatus 600 according to an embodiment of the present disclosure, including the display device 500 described above. The electronic apparatus is, for example, an electronic photo frame, a mobile phone, a computer, a tablet computer, a display screen, a wearable device, or the like.

The method for displaying an image on a display device according to an embodiment of the present disclosure may adjust display parameters for indoor and outdoor environments so as to achieve desired smart display effects.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for displaying an image on a display device, comprising:
acquiring environmental information for the display device; and
determining display parameters of the display device for image display according to the environmental information.

2. The method according to claim 1, wherein acquiring the environmental information for the display device comprises:
acquiring a geographic position and current time for the display device; and
acquiring weather information corresponding to the geographic position and the current time.

3. The method according to claim 2, wherein determining display parameters of the display device for image display according to the environmental information comprises:
determining color temperature and luminance of light based on the weather information and the current time; and
determining the display parameters of the display device based on the color temperature and the luminance.

4. The method according to claim 1, wherein acquiring environmental information of the display device comprises:
capturing an indoor image of an indoor environment in which the display device is located; and
analyzing the indoor image to determine display parameters of the indoor image,
wherein the display parameters of the display device for image display are determined based on the display parameters of the indoor environment.

5. The method according to claim 1, further comprising:
acquiring indoor space information of an indoor environment in which the display device is located, the indoor space information including a position of an illumination source;
detecting a position of eyes of a user who is viewing the display device;
determining a relative position between the display device and the user's eyes;
determining, according to the indoor space information and the relative position, an area of the display device that reflects light from the illumination source to the user's eyes; and
adjusting luminance of the display device such that the luminance in the area of the display device is higher than the luminance in other area of the display device.

6. The method according to claim 1, further comprising:
storing the display parameters of the display device in association with the environmental information.

7. The method according to claim 1, wherein the display parameters comprise at least one of color temperature and luminance.

8. A display device, comprising:
an information acquisition module configured to acquire environmental information for the display device; and
a processor configured to determine display parameters of the display device for image display according to the environmental information.

9. The display device according to claim 8, wherein the information acquisition module comprises:
a communication unit configured to receive current time and weather information.

10. The display device according to claim 9, wherein the processor is further configured to
determine color temperature and luminance of light based on the weather information and the current time, and
determine the display parameters of the display device based on the color temperature and the luminance.

11. The display device according to claim 8, wherein the information acquisition module comprises:
a timing system configured to acquire current time for the display device;
a positioning unit configured to acquire a geographic position for the display device; and
a communication unit configured to transmit the acquired current time and geographic position to an external server and receive from the server weather information corresponding to the geographic position and the current time.

12. The display device according to claim 11, wherein the processor is further configured to
determine color temperature and luminance of light based on the weather information and the current time, and
determine the display parameters of the display device based on the color temperature and the luminance.

13. The display device according to claim 8, wherein the information acquisition module comprises:
a spectral sensor configured to acquire color temperature of environmental light; and
a light intensity sensor configured to acquire luminance of the environmental light,
wherein the processor is further configured to determine the display parameters of the display device for image display based on the color temperature and luminance of the environmental light.

14. The display device according to claim 8, wherein the information acquisition module comprises:
a camera configured to capture an indoor image of an indoor environment in which the display device is located; and
an analysis unit configured to analyze the indoor image to determine display parameters of the indoor image,
wherein the processor is further configured to determine the display parameters of the display device for image display based on the display parameters of the indoor image.

15. The display device according to claim 8, further comprising:
a binocular camera configured to acquire indoor space information of an indoor environment in which the display device is located, the indoor space information including a position of an illumination source; and
an infrared sensor configured to detect a position of eyes of a user who is viewing the display device,
wherein the processor is further configured to determine a relative position between the display device and the user's eyes, determine an area of the display device that reflects light from the illumination source to the user's eyes according to the indoor space information and the relative position, and adjust luminance of the display device such that the luminance in the area of the display device is higher than the luminance in other area of the display device.

16. The display device according to claim 8, further comprising a memory configured to store the display parameters of the display device corresponding to the environmental information.

17. The display device according to claim 8, wherein the display parameters comprise at least one of color temperature and luminance.

18. An electronic apparatus comprising the display device according to claim 8.
